(19) United States
(12) Patent Application Publication
(10) Pub. No.: US 2017/0256009 A1
(43) Pub. Date: Sep. 7, 2017

(54) MARKETING REAL ESTATE SERVICES BASED ON LISTING STATUS

(71) Applicant: Thomas J. Thorne, II, Charlotte, NC (US)

(72) Inventor: Thomas J. Thorne, II, Charlotte, NC (US)

(21) Appl. No.: 15/060,338

(22) Filed: Mar. 3, 2016

(51) Int. Cl. G06Q 50/16; G06Q 50/00; H04L 12/58; G06Q 30/02

(52) U.S. Cl. CPC G06Q 50/163; G06Q 30/0277; G06Q 50/01; H04L 51/32; G06Q 30/0255

(57) ABSTRACT

Techniques and architectures generate targeted advertisements or notifications in response to a changing of status of a real property listed by a listing service. The change of listing status may indicate a consumer demand for professional services most appropriate for the timing and status of the real property or other properties that an agent or seller of the real property may pursue at a later time.

### BACKGROUND

Real estate properties are often listed in a multiple listings service (MLS). Status of such listings may be “active”, “pending”, “closed”, “withdrawn”, or “expired”. Various types of businesses and professional services may be associated with the sale and/or purchase of real estate. For example, in addition to real estate agents, mortgage brokers, home inspectors, appraisers, attorneys, title companies, cleaning services, and repair/construction contractors, among others, may be involved with a home undergoing a sale or purchase.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a block diagram illustrating an example timeline of the sale of a real property.

FIG. 3 is a block diagram of multiple information sources that may communicate with an example communication generator module.

FIG. 4 is a flow diagram of an example process for performing targeted advertising of real-estate related services.

### DETAILED DESCRIPTION

Various examples describe techniques and architectures for a system that performs, among other things, targeted marketing and/or sales processes based, at least in part, on status and/or change of status in one or more real estate listings. A real estate listing, for example, may be a description of residential or commercial property, such as a business, a house, an apartment, a condominium, a building, a lot, agricultural land, forest land, acreage, and so on, which is the subject of a sales transaction. The real estate listing may be in one of several statuses, such as active, pending, and inactive. For example, the listing may be active, where the property is currently for sale. The real estate listing may be pending, where the property is at least partially off the market while a purchase transaction for a party to purchase the property is pending. Pending status may involve, for example, an accepted offer to purchase the property, being in escrow, and/or under contract. The real estate listing may be closed, where the property is no longer for sale, and may be subsequent to a recent purchase. Other listing statuses may include withdrawn or expired listings, for example.

Though embodiments herein may involve any type of real estate, descriptions will focus on residential properties, such as houses, apartments, condominiums, etc.

There are a number of businesses that are peripheral to real estate sales and marketing (e.g., wherein such sales and marketing is performed by real estate agents). Such peripheral businesses, for example, may include home inspection services, appraisal services, lending services, legal services, title services, surveyor services, home cleaning services, home repair and construction services, and so on. Such businesses may perform services that are coordinated with different aspects of the selling/purchasing of a home. In some embodiments, the different aspects of the sell/purchase of a home may be represented by the status, or the change of status, of the real estate listing for the home. Thus, for example, particular types of businesses may perform services for properties that are in a particular status. Moreover, some particular types of businesses perform services for properties that are in a particular transition from one status to a subsequent status.

A change of status of a real estate listing may provide marketing and sales opportunities for particular types of businesses that perform services for properties within that particular status of the listing. For example, a listing placed on the market may be first placed on the multiple listing services (MLS) as an “active” listing. This active status may provide a marketing/sale opportunity for a home inspection business. Marketing of the home inspector's business may be targeted to a real estate agent (e.g., seller of real estate) or their client.

The home inspector may send a personalized email to individual listing agents for each of the status changes that the listing experiences. For example, when a home first comes on the market and is an “active” listing, an appraiser, being aware of the new listing, may send an email to the listing agent (or seller). The email may be an advertisement or a more personalized letter saying that if the listing agent (or seller) has a need for a home measuring service to please let the appraiser know, because the appraiser performs this type of work and can perform this service for the listing agent. When the listing status of the home goes from active status to pending status, a different service provider (e.g., peripheral business), such as a home inspector or mortgage lender, may send an email to the listing agent (or seller). The email may be an advertisement or a more personalized letter saying that if the listing agent (or seller) has a need for a qualified home inspector to please let the home inspector know, because the home inspector performs this type of work and can perform this service for the listing agent. In a similar example, such as from a mortgage lender, the email may be an advertisement or a more personalized letter saying that if the listing agent (or seller) has a need for a mortgage lender to please let the mortgage lender know, because the mortgage lender performs this type of work (e.g., for the clients of the listing agent) and can perform this service for the listing agent (or seller).

In some embodiments, different products or services may be offered or sold to a listing agent (or customer, seller, client, etc.) for a listing, based, at least in part, on which phase or status the listing is in. For example, particular types of businesses or services may find certain statuses of a listing more “interesting” as compared to other statuses of a listing. Thus, for example, such particular businesses or services may wish to target listings in particular statuses. For instance, an appraiser likely would not find much benefit in marketing their services during a “pending” phase of a listing. In another example, a mortgage lender likely would not find much benefit in marketing their services during the “active” phase. Such businesses (e.g., professionals) may use an MLS to find business opportunities (e.g., to find “more work”), but timing (e.g., the status or change of status) of the listings may be important.

In some embodiments, marketing to a real estate listing agent in a “pending” phase for a house need not be for purposes of selling the listing agent products or services for the house. Instead, marketing to the real estate listing agent may be for purposes of selling the listing agent products or services for a different house. For example, if a home seller sells their house using a real estate agent then the home seller is most likely to use that same real estate agent to purchase another (e.g., “second”) home. This other home (or the purchase process thereof) may need the services of a home inspector or mortgage lender, for example.

Information of a listing agent and status changes of a listing may be found using any of a number of techniques. For example, information may be placed on an MLS and syndicated to websites across the Internet. Such information may be updated on the websites within a relatively short time (e.g., fifteen minutes or so) of being updated on the MLS. Listing agents' information may be similarly found from the MLS or from different sources across the Internet.

In some examples, real estate based content may be extracted from multiple forms of communications, including any of a number of applications that involve real estate, digital content capturing interpersonal communications (e.g., email, SMS text, instant messaging, phone calls, posts in social media, and so on) and composed content (e.g., email, calendars, word-processing documents, and so on). For example, text from an email may include an indication that an offer to purchase a house has been accepted by the seller and the house will soon be in escrow. A computer system may automatically determine, from such text, that the house will be placed in a pending status and subsequently perform methods of targeted advertising using techniques such as those described herein.

In some embodiments, a multiple listing service (MLS, also multiple listing system, or multiple listings service) may be a suite of services that enables real estate agents or brokers to establish contractual offers of compensation (among brokers), facilitates cooperation with other broker participants, accumulates and disseminates information to enable appraisals, and may be a facility for the orderly correlation and dissemination of listing information to better serve broker's clients, customers and the public, for example. A multiple listing service's database and software may be used by real estate agents or brokers in real estate, representing seller under a listing contract to widely share information about properties with other agents or brokers who may represent potential buyers or wish to cooperate with a seller's agent or broker in finding a buyer for the property or asset.

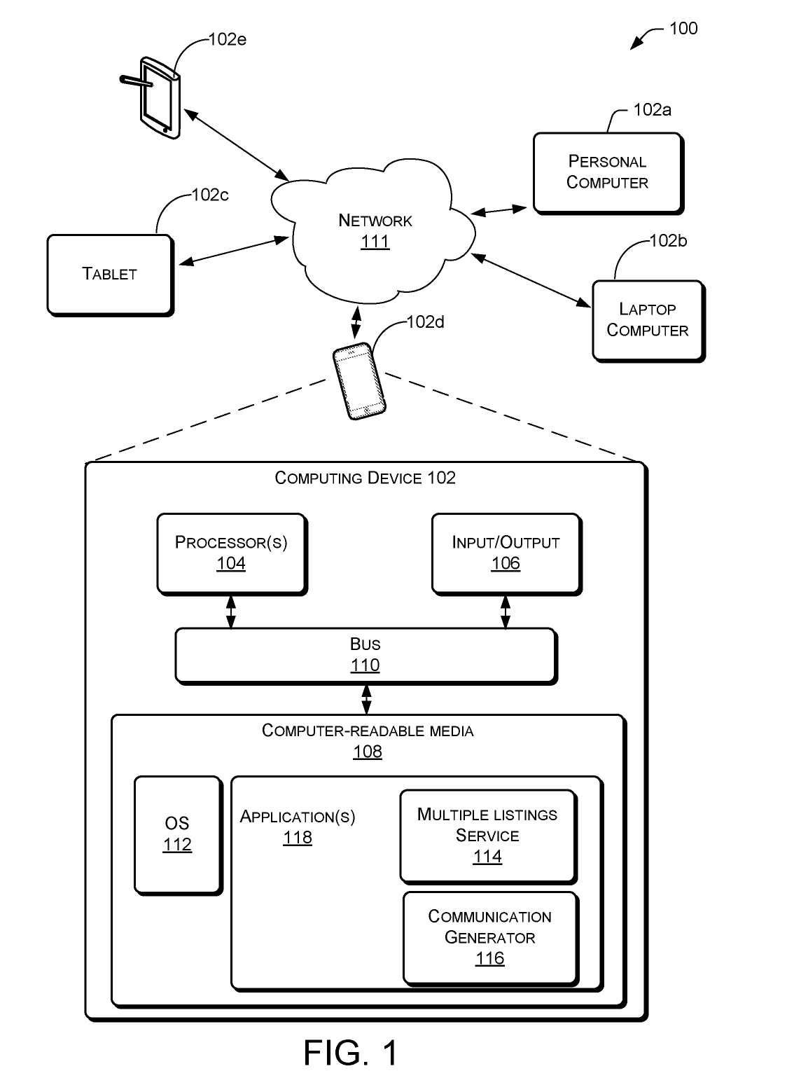

Various examples are described further with reference to FIGS. 1-4.

The environment described below constitutes but one example and is not intended to limit the claims to any one particular operating environment. Other environments may be used without departing from the spirit and scope of the claimed subject matter.

FIG. 1 illustrates an example environment 100 in which example processes involving monitoring listing status, automatic Internet searches, and management of generating and sending communications as described herein can operate. In some examples, the various devices and/or components of environment 100 include a variety of computing devices 102. By way of example and not limitation, computing devices 102 may include devices 102a-102e. Although illustrated as a diverse variety of device types, computing devices 102 can be other device types and are not limited to the illustrated device types. Computing devices 102 can comprise any type of device with one or multiple processors 104 operably connected to an input/output interface 106 and computer-readable media 108, e.g., via a bus 110. Computing devices 102 can include personal computers such as, for example, desktop computers 102a, laptop computers 102b, tablet computers 102c, telecommunication devices 102d, personal digital assistants (PDAs) 102e, electronic book readers, wearable computers (e.g., smart watches, personal health tracking accessories, etc.), automotive computers, gaming devices, etc. Computing devices 102 can also include, for example, server computers, thin clients, terminals, and/or work stations. In some examples, computing devices 102 can include components for integration in a computing device, appliances, or other sorts of devices.

In some examples, some or all of the functionality described as being performed by computing devices 102 may be implemented by one or more remote peer computing devices, a remote server or servers, or distributed computing resources, e.g., via cloud computing. In some examples, a computing device 102 may comprise an input port to receive electronic communications. Computing device 102 may further comprise one or multiple processors 104 to access various sources of information related to or associated with particular electronic communications. Such sources may include MLS or other real estate databases and databases of histories or personal information about listing agents, real estate purchasers and seller, and government (e.g., county tax) records, just to name a few examples. Other sources of information may include online databases or website content of Zillow Group®, Trulia®, and other similar services, for example. One or multiple processors 104 may be hardware processors or software processors. As used herein, a processing unit designates a hardware processor.

In some examples, as shown regarding device 102d, computer-readable media 108 can store instructions executable by the processor(s) 104 including an operating system (OS) 112, an MLS module 114, a communication generator module 116, and programs or applications 118 that are loadable and executable by processor(s) 104. The one or more processors 104 may include one or more central processing units (CPUs), graphics processing units (GPUs), video buffer processors, and so on. In some implementations, MLS module 114 comprises executable code stored in computer-readable media 108 and is executable by processor(s) 104 to collect information, locally or remotely by computing device 102, via input/output 106. The information may be associated with one or more of applications 118. MLS module 114 may selectively apply any of a number of database search routines stored in computer-readable media 108 (or, more particularly, stored in MLS module 114) to apply to input data.

In some implementations, communication generator module 116 comprises executable code stored in computer-readable media 108 and is executable by processor(s) 104 to generate text that includes targeted advertisement of professional service associated with real estate transactions, for example. Such communications may be transmitted (e.g., sent) via input/output 106. The communications may be generated using one or more of applications 118.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Computer readable media includes computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory (e.g., USB drives) or other memory technology, compact disk read-only memory (CD-ROM), external hard disks, digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, memory 108 is an example of computer storage media storing computer-executable instructions. When executed by processor(s) 104, the computer-executable instructions configure the processor(s) to, among other things, receive data indicating a change of status of a property listing for a property via the transceiver port; retrieve contact information for an agent of the property listing or for a seller of the property; and generate a communication that includes a description of professional services associated with a purchase of a property.

In various examples, an input device of or connected to input/output (I/O) interfaces 106 may be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106, which may comprise one or more communications interfaces to enable wired or wireless communications between computing device 102 and other networked computing devices involved in extracting task content, or other computing devices, over network 111. Network 111 may include (or provide access and communications to/from) the Internet, websites, MLS databases, and so on. Such communications interfaces may include one or more transceiver devices, e.g., network interface controllers (NICs) such as Ethernet NICs or other types of transceiver devices, to send and receive communications over a network. Processor 104 (e.g., a processing unit) may exchange data through the respective communications interfaces. In some examples, a communications interface may be a PCIe transceiver, and network 111 may be a PCIe bus. In some examples, the communications interface may include, but is not limited to, a transceiver for cellular (3G, 4G, or other), WI-FI, Ultra-wideband (UWB), BLUETOOTH, or satellite transmissions. The communications interface may include a wired I/O interface, such as an Ethernet interface, a serial interface, a Universal Serial Bus (USB) interface, an INFINIBAND interface, or other wired interfaces. For simplicity, these and other components are omitted from the illustrated computing device 102. Input/output (I/O) interfaces 106 may allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

In some embodiments, a method comprises receiving information regarding a change in listing status of a first real estate transaction for a first property (e.g., house). Such a method, or portions thereof, may be automatically performed by a computer system such as 102. The information regarding the change in listing status may be from one or more data sources, such as the Internet (e.g., via network 111), an MLS, a database (which may be updated periodically or from time to time, for example), or other sources. In a particular implementation, the change in listing status is from active status to pending status. For example, a listed house may be in an active status wherein the first house is available for purchase to the general public. Subsequently, the first house may enter a pending status while a particular (potential) purchaser is buying the first house. Such a purchase includes a process that may take weeks or longer, during which the listing status may be pending.

In response to receiving the information that the listing status has changed from active to pending, a communication may be generated manually or by communication generator module 116 and may include text or other media that advertises services applicable for a “second” property (e.g., house). (In other embodiments, the communication may include text that advertises services applicable for the first property instead of, or in addition to, the second property). Such a second house may not be any particular house, but may be a general concept related to the potential of the seller of the first house potentially (and perhaps likely) purchasing a second house upon or after the closing of the sale of the first property. In particular, it may be likely that the seller will use the same agent of the first house to purchase the second house. Thus, a technique of targeting marketing of particular services may include sending (e.g., perhaps automatically by a computer) the generated communication to the agent associated with the first real estate transaction (e.g., the selling of the first house) or to seller (e.g., the former owners) of the first real estate transaction.

For example, the generated communication may include a letter (which may be personalize and have a general “warm feeling”) regarding home inspection services. Home inspection services may be particularly useful for the seller of the first house while they purchase the second house. Undesirably, if such a communication were to be sent to the seller while their first house is still in an active status, the communication may be relatively ineffective because a need for home inspection services for the seller is most likely in the distant future.

In some examples, generated communication may include a cost estimate for home inspection services for the second property based, at least in part, on the listed sale price for the first property. In still other examples, generated communication may include a coupon, discount offers or promotions, etc.

In another example, the generated communication may include a letter regarding home mortgage services. Home mortgage services may be particularly useful for the seller of the first house while they purchase the second house. Undesirably, if such a communication were to be sent to the seller while their first house is still in an active status, the communication may be relatively ineffective because a need for home mortgage services for the seller is most likely in the distant future. In some examples, the communication may include mortgage cost estimation for the second property based, at least in part, on the listing price of the first house.

For example, the communication may include a sample “good faith estimate” (GFE), which may be an itemized list of estimated fees and costs (e.g., mortgage fees, settlement costs, closing costs, various expenses associated with a home loan, including inspections, title insurance, taxes and other charges associated with a potential loan) that is predicted to be appropriate for the seller of the first house in purchasing the second house. Such an estimated GFE, which need not be an actual GFE (and may be labelled to identify that it is not to be construed as an actual GFE), may be automatically generated by a computer system based, at least in part, on the listing price of the first house. Additionally, if personal information (e.g., annual income, size of family, value of assets, value of previously-owned houses, location of extended family members, and so on) of the seller of the first house is known a priori, such as from a database of historical data, an estimated GFE and loan value may be automatically generated by the computer system based, at least in part, on the listing price of the first house and/or the personal information of the seller, for example.

The generated communication being sent to its target audience (e.g., the listing agent and/or the seller of the first house) relatively soon after the listing status changes from active to pending may be beneficial: waiting too long may result in the agent or seller finding another provider of the service. Thus, it may be beneficial to send the generated communication within minutes (e.g., anywhere in a range from less than a minute to about 24 hours or so) of the listing status change. This process of prompt letter generation and sending may be performed automatically by a computer system (with human oversight in some implementations).

In some examples, the generated communication may include a letter, social media posts or outreach of other media (e.g., Twitter®, LinkedIn®, Facebook®, YouTube®, etc.), SMS text, instant messaging, a phone call, email, Fax, and so on.

In a particular example, a generated letter may be “Greetings Mr. Smith, I'm the owner of Boone and TJ Home Inspections. I just wanted to reach out and introduce myself. If you or your clients ever need a good home inspector, I'd love to help you out! Thanks for keeping me in mind! Sincerely, T J Thorne.” For another example, “I just wanted to send you a quick email wishing you a happy 2016! If you need a great home inspector this year I'd love to help you out. Feel free to check out my website or Google “Boone and TJ Home Inspections” to read my awesome Google Reviews. I hope to talk with you soon!” In some implementations, such communications may be automatically generated. In other implementations, such communications may be at least partially manually drafted by personnel. In such a case, for example, a computer system may automatically provide (e.g., send or transmit) notifications and/or lists of properties that have experienced a change in listing status to such personnel. The personnel may respond by drafting communications targeted for agents or a seller of a property that is on such a notification list. For example, the personnel may comprise an individual professional or a group of professionals (or assistants thereof) that provide real estate based services (e.g., home inspections, home mortgages, home cleaning, painting, construction, and so on).

In some embodiments, a database may be generated (e.g., or built upon) for maintaining statistics regarding response of agents or sellers to the generated communications. For example, useful information that may be stored in a database may include what percentage of the time a particular real estate agent has responded to generated communications, what are the values of the associated real estate transactions, time span between sent communication and response, how often a particular seller has a house on the market, historical performance of particular real estate agents, how much work of particular services have occurred in association with particular real estate agents or sellers, etc.

In some examples, the method may include assigning a class to the first property based, at least in part, on a listed sale price for the first house, wherein the communication is generated based, at least in part, on the class of the first property. Such a class may be useful for predicting the cost (or range thereof) of the second house that the seller likely will target. For example, if the listed sale price of the first house is $250,000, then the seller may likely search for a second house with a cost of about $250,000 (of course the seller may be upgrading or downgrading so that the cost of the second house will be different from that of the first house, and such costs information may be stored in a database and used for future predictions or estimations).

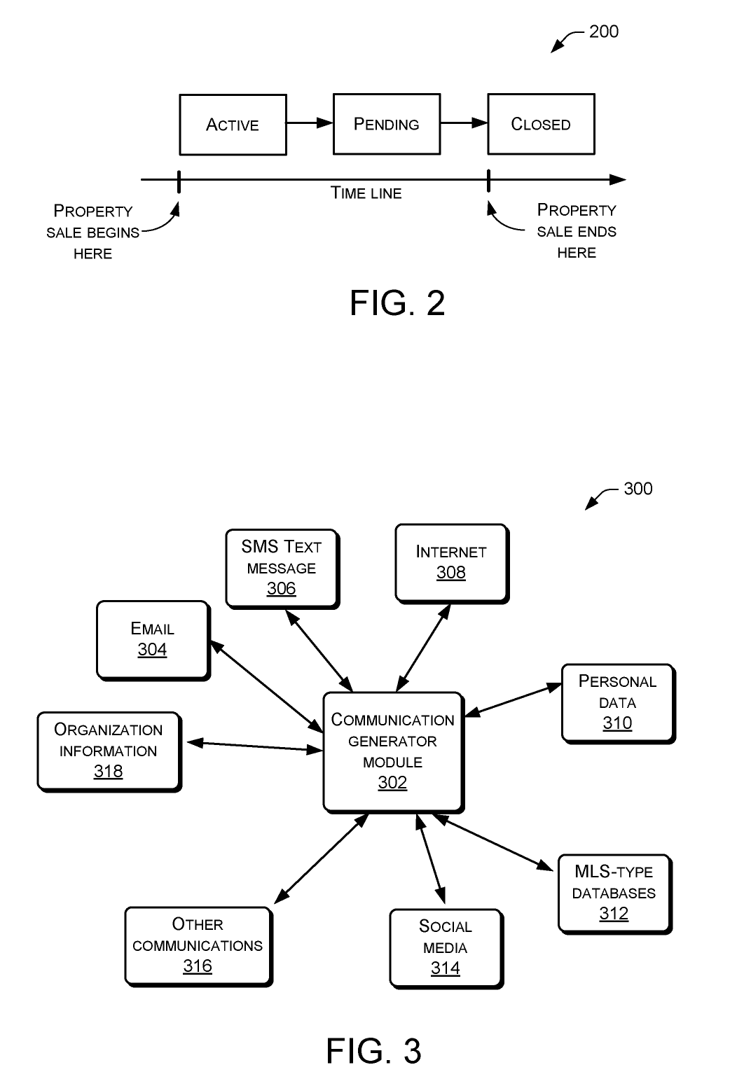

FIG. 2 is an example timeline 200 that illustrates a general sequence of the sale of real estate property, such as a house. An act of selling the house may begin with the house being actively listed (active status) in the MLS or other real estate database, for example. If a purchase offer is initiated, the listing may enter a pending status. Upon or shortly after the purchase is finalized, the status is closed. Of course there are cases where a pending status may return to active status, such as if the pending purchase falls through (e.g., fails). Often, the house will return to a pending status if another purchaser begins the purchase process.

FIG. 3 is a block diagram of an example system 300 that includes a communication generator module 302 in communication with a number of entities 304-318. Such entities may include host applications (e.g., Internet browsers, SMS text editors, email applications, and so on), databases or information sources (e.g., MLS or other such databases, organizational information of real estate-related businesses or agencies, third party data aggregators that might provide data as a service, and so on), just to name a few examples. Communication generator module 302 may be the same as or similar to communication generator module 116 in computing device 102, illustrated in FIG. 1, for example.

Communication generator module 302 may be configured to analyze content of communications, and/or data or information provided by entities 304-318 by applying any of a number of browser or language analysis techniques (though simple heuristical or rule-based systems may also be employed).

For example, communication generator module 302 may be configured to analyze content of communications provided by email entity 304, SMS text message entity 306, and so on. Communication generator module 302 may also be configured to analyze data or information provided by Internet entity 308, and so on. Communication generator module 302 may analyze content by applying language analysis to information or data collected from any of entities 304-318.

Double-ended arrows in FIG. 3 indicate that data or information may flow in either or both directions among entities 304-318 and communication generator module 302. For example, data or information flowing from communication generator module 302 to any of entities 304-318 may result from communication generator module 302 providing targeted advertisements or information about real estate services to entities 304-318.

Organizational information 318 may involve or include data regarding real estate agencies, real estate brokerage firms, etc. Personal data 310 may include information (or sources thereof) regarding real estate agents, real estate purchasers and buyers, and so on.

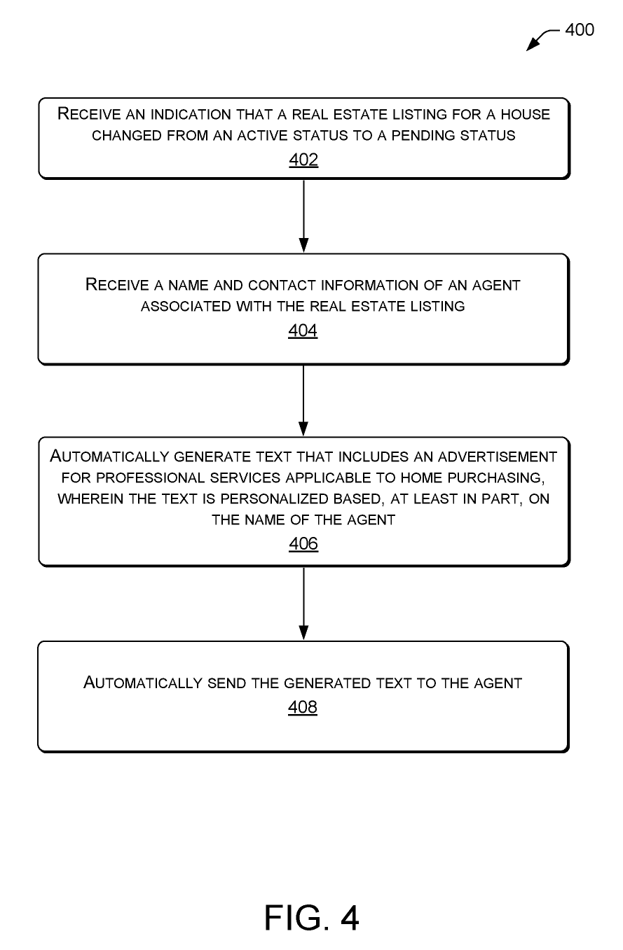

FIG. 4 is a flow diagram of a process 400 for performing targeted advertising of real-estate related services, for example. For example, communication generator module 302, illustrated in FIG. 3, may perform process 400. At block 402, communication generator module 302 may receive an indication that a real estate listing for a house changed from an active status to a pending status. At block 404, communication generator module 302 may receive a name and contact information of an agent associated with the real estate listing. At block 406, communication generator module 302 may automatically generate text that includes an advertisement for professional services applicable to home purchasing. For example, the text may be personalized based, at least in part, on the name of the agent.

At block 408, communication generator module 302 may automatically send the generated text to the agent.

The flow of operations illustrated in FIG. 4 is illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any descriptions, elements, or blocks in the flows of operations illustrated in FIG. 4 may represent modules, segments, or portions of code that include one or more executable instructions for implementing specific logical functions or elements in the process.

In some embodiments, a computing device may comprise a transceiver port to receive and to transmit data (e.g., 106); one or more processors (e.g., 104); and a memory (e.g., 108) storing instructions that, when executed by the one or more processors, cause the one or more processors to perform operations comprising: receive data indicating a change of status of a property listing for a property via the transceiver port; retrieve contact information for an agent of the property listing or for a seller of the property; and generate a communication that includes a description of professional services associated with a purchase of a property.

In some examples, the operations may further comprise sending the communication to the agent and/or to the seller. In some examples, the operations may further comprise sending the communication to a business that performs the professional services. In some examples, the operations may further comprise scanning or monitoring the Internet for the data indicating the change of status. In some examples, the operations may further comprise retrieving the contact information for the agent of the property listing or for the seller of the property by scanning the Internet. In some cases, the professional services may include home inspection services. In other cases, the professional services may include home mortgage services.

In some embodiments a method may comprise receiving an indication that a real estate listing for a house changed from an active status to a pending status; receiving a name and contact information of an agent associated with the real estate listing; automatically generating text that includes an advertisement for professional services applicable to home purchasing, wherein the text is personalized based, at least in part, on the name of the agent; and automatically sending the generated text to the agent. In some examples, the professional services may include home inspection services. The text may be further personalized based, at least in part, on a performance history of the agent. The indication that the real estate listing for the house changed from the active status to the pending status may be automatically received from a multiple listing service (MLS). In some cases, the method may include comparing the name and contact information of the agent to information stored in a database.

In some embodiments, information may be obtained manually through the MLS or other internet websites or a computer program may gather such information. A computer program may gather information using a fee or paid service provided by a particular service/company or the computer program may obtain information through cross referencing. An example of cross referencing is if the computer program sees that “listing A” of “agent B” changes status, then the computer program can scrape the Internet and determine contact information (e.g., phone number, email address, company the agent works for, etc.) for “agent A”.

In some embodiments, a listing status change notification may include the seller information and include the seller in marketing processes. For example, either manually or by a computer program, the owner's name and/or other personal information may be collected for a listing through county tax records, for example. Such information may also be cross-referenced with other sources (e.g., various databases) to obtain more information for the seller. The seller may then be marketed to directly.

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A method comprising:
receiving information regarding a change in listing status of a first real estate transaction for a first property from one or more data sources, wherein the change in listing status is from active status to pending status;
in response to receiving the information, generating a communication that includes advertising services applicable for a second property; and
sending the communication to an agent associated with the first real estate transaction or to a seller of the first real estate transaction.

2. The method of claim 1, wherein the services include home inspection services.

3. The method of claim 1, wherein the services include home mortgage services.

4. The method of claim 1, wherein the one or more data sources include a multiple listings service (MLS).

5. The method of claim 1, wherein the communication comprises a social media communication.

6. The method of claim 1, further comprising:
assigning a class to the first property based, at least in part, on a listed sale price for the first property, wherein the communication is generated based, at least in part, on the class of the first property.

7. The method of claim 6, wherein the communication includes a mortgage cost estimation for the second property based, at least in part, on the class of the first property or the listed sale price for the first property.

8. The method of claim 6, wherein the communication includes a cost estimate for home inspection services for the second property based, at least in part, on the class of the first property or the listed sale price for the first property.

9. A computing device comprising:
a transceiver port to receive and to transmit data;
one or more processors; and
a memory storing instructions that, when executed by the one or more processors, cause the one or more processors to perform operations comprising:
receive data indicating a change of status of a property listing for a property via the transceiver port;
retrieve contact information for an agent of the property listing or for a seller of the property; and
generate a communication that includes a description of professional services associated with a purchase of a property.

10. The computing device of claim 9, wherein the operations further comprise:
sending the communication to the agent and/or to the seller.

11. The computing device of claim 9, wherein the operations further comprise:
sending the communication to a business that performs the professional services.

12. The computing device of claim 9, wherein the operations further comprise:
scanning or monitoring the Internet for the data indicating the change of status.

13. The computing device of claim 9, wherein the operations further comprise:
retrieving the contact information for the agent of the property listing or for the seller of the property by scanning the Internet.

14. The computing device of claim 9, wherein the professional services include home inspection services.

15. The computing device of claim 9, wherein the professional services include home mortgage services.

16. A method comprising:
receiving an indication that a real estate listing for a house changed from an active status to a pending status;
receiving a name and contact information of an agent associated with the real estate listing;
automatically generating text that includes an advertisement for professional services applicable to home purchasing, wherein the text is personalized based, at least in part, on the name of the agent; and
automatically sending the generated text to the agent.

17. The method of claim 16, wherein the professional services include home inspection services.

18. The method of claim 16, wherein the text is further personalized based, at least in part, on a performance history of the agent.

19. The method of claim 16, wherein the indication that the real estate listing for the house changed from the active status to the pending status is automatically received from a multiple listing service (MLS).

20. The method of claim 16, further comprising comparing the name and contact information of the agent to information stored in a database.
